(19) United States
(12) Patent Application Publication
(10) Pub. No.: US 2020/0379716 A1
(43) Pub. Date: Dec. 3, 2020

(54) AUDIO MEDIA USER INTERFACE

(71) Applicant: Apple Inc., Cupertino, CA (US)

(72) Inventor: Taylor G. CARRIGAN, San Francisco, CA (US)

(21) Appl. No.: 16/723,583

(22) Filed: Dec. 20, 2019

Related U.S. Application Data
(60) Provisional application No. 62/855,901, filed on May 31, 2019.

(51) Int. Cl. G06F 3/16; G06F 3/0362; G06F 3/0484

(52) U.S. Cl. CPC G06F 3/165; G06F 3/04847; G06F 3/0362

(57) ABSTRACT

A method includes displaying an audio media user interface having a predefined control layout that includes a first control location and a second control location. In accordance with the audio media user interface corresponding to a first audio media application, the first control location includes a first media control affordance that, when selected, performs a first audio control function, and the second control location includes a second media control affordance that, when selected, performs a second audio control function. In accordance with the audio media user interface corresponding to a second audio media application, the first control location includes a third media control affordance that, when selected, performs a third audio control function different from the first audio control function, and the second control location includes a fourth media control affordance that, when selected, performs a fourth audio control function different from the second audio control function.

### CROSS-REFERENCE TO RELATED APPLICATIONS

This application claims priority to U.S. Provisional Patent Application Ser. No. 62/855,901, titled “AUDIO MEDIA USER INTERFACE,” filed May 31, 2019, the content of which is hereby incorporated by reference in its entirety.

### FIELD

The present disclosure relates generally to computer user interfaces, and more specifically to techniques for controlling audio media.

### BACKGROUND

There are various types of audio media, such as music tracks, podcasts, videos that include sound, and audio books. Users desire to play these various types of audio media on various types of electronic devices that have audio output capability, such as desktop computers, laptops, tablets, phones, watches, and wireless speakers.

### BRIEF SUMMARY

Some techniques for controlling audio media using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling audio media. Such methods and interfaces optionally complement or replace other methods for controlling audio media. Such methods and interfaces reduce the cognitive burden on a user and produce a more efficient human-machine interface. For battery-operated computing devices, such methods and interfaces conserve power and increase the time between battery charges.

Example methods are disclosed herein. An example method includes, at an electronic device with a display device: receiving a request to display an audio media user interface; and in response to receiving the request to display an audio media user interface, displaying, via the display device, an audio media user interface having a predefined control layout that includes a first control location at a first location in the audio media user interface and a second control location at a second location in the audio media user interface, wherein displaying the audio media user interface includes: in accordance with the request corresponding to a request to display an audio media user interface of a first audio media application: displaying, at the first control location, a first media control affordance that, when selected, performs a first audio control function; and displaying, at the second control location, a second media control affordance that, when selected, performs a second audio control function; and in accordance with the request corresponding to a request to display an audio media user interface of a second audio media application: displaying, at the first control location, a third media control affordance that, when selected, performs a third audio control function, different from the first audio control function; and displaying, at the second control location, a fourth media control affordance that, when selected, performs a fourth audio control function, different from the second audio control function.

Example non-transitory computer-readable storage media are described herein. An example non-transitory computer-readable storage medium stores one or more programs configured to be executed by one or more processors of an electronic device with a display device, the one or more programs including instructions for: receiving a request to display an audio media user interface; and in response to receiving the request to display an audio media user interface, displaying, via the display device, an audio media user interface having a predefined control layout that includes a first control location at a first location in the audio media user interface and a second control location at a second location in the audio media user interface, wherein displaying the audio media user interface includes: in accordance with the request corresponding to a request to display an audio media user interface of a first audio media application: displaying, at the first control location, a first media control affordance that, when selected, performs a first audio control function; and displaying, at the second control location, a second media control affordance that, when selected, performs a second audio control function; and in accordance with the request corresponding to a request to display an audio media user interface of a second audio media application: displaying, at the first control location, a third media control affordance that, when selected, performs a third audio control function, different from the first audio control function; and displaying, at the second control location, a fourth media control affordance that, when selected, performs a fourth audio control function, different from the second audio control function.

Example transitory computer-readable storage media are described herein. An example transitory computer-readable storage medium stores one or more programs configured to be executed by one or more processors of an electronic device with a display device, the one or more programs including instructions for: receiving a request to display an audio media user interface; and in response to receiving the request to display an audio media user interface, displaying, via the display device, an audio media user interface having a predefined control layout that includes a first control location at a first location in the audio media user interface and a second control location at a second location in the audio media user interface, wherein displaying the audio media user interface includes: in accordance with the request corresponding to a request to display an audio media user interface of a first audio media application: displaying, at the first control location, a first media control affordance that, when selected, performs a first audio control function; and displaying, at the second control location, a second media control affordance that, when selected, performs a second audio control function; and in accordance with the request corresponding to a request to display an audio media user interface of a second audio media application: displaying, at the first control location, a third media control affordance that, when selected, performs a third audio control function, different from the first audio control function; and displaying, at the second control location, a fourth media control affordance that, when selected, performs a fourth audio control function, different from the second audio control function.

Example electronic devices are described herein. An example electronic device includes a display device; one or more processors; and memory storing one or more programs configured to be executed by the one or more processors, the one or more programs including instructions for: receiving a request to display an audio media user interface; and in response to receiving the request to display an audio media user interface, displaying, via the display device, an audio media user interface having a predefined control layout that includes a first control location at a first location in the audio media user interface and a second control location at a second location in the audio media user interface, wherein displaying the audio media user interface includes: in accordance with the request corresponding to a request to display an audio media user interface of a first audio media application: displaying, at the first control location, a first media control affordance that, when selected, performs a first audio control function; and displaying, at the second control location, a second media control affordance that, when selected, performs a second audio control function; and in accordance with the request corresponding to a request to display an audio media user interface of a second audio media application: displaying, at the first control location, a third media control affordance that, when selected, performs a third audio control function, different from the first audio control function; and displaying, at the second control location, a fourth media control affordance that, when selected, performs a fourth audio control function, different from the second audio control function.

An example electronic device includes a display device; and means for receiving a request to display an audio media user interface; and means for, in response to receiving the request to display an audio media user interface, displaying, via the display device, an audio media user interface having a predefined control layout that includes a first control location at a first location in the audio media user interface and a second control location at a second location in the audio media user interface, wherein displaying the audio media user interface includes: in accordance with the request corresponding to a request to display an audio media user interface of a first audio media application: displaying, at the first control location, a first media control affordance that, when selected, performs a first audio control function; and displaying, at the second control location, a second media control affordance that, when selected, performs a second audio control function; and in accordance with the request corresponding to a request to display an audio media user interface of a second audio media application: displaying, at the first control location, a third media control affordance that, when selected, performs a third audio control function, different from the first audio control function; and displaying, at the second control location, a fourth media control affordance that, when selected, performs a fourth audio control function, different from the second audio control function.

An example method includes, at an electronic device with a housing, a rotatable input device configured to rotate relative to the housing, and a display device: displaying, via the display device, an audio media user interface of an application that provides an audio output, the audio media user interface including a first graphical element at a first location on the audio media user interface adjacent to the rotatable input device, the first graphical element indicating a first volume level, detecting a rotation of the rotatable input device; in response to detecting a rotation of the rotatable input device, displaying a second graphical element on the audio media user interface, wherein: the second graphical element is different from the first graphical element, the second graphical element indicates a second volume level that is based on a magnitude of the rotation of the rotatable input device, and the second volume level is different from the first volume level; and after detecting that the rotation of the rotatable input device has ceased, displaying a third graphical element at the first location on the audio media user interface, wherein: the third graphical element indicates the second volume level; and the third graphical element is different from the second graphical element.

An example non-transitory computer-readable storage medium stores one or more programs configured to be executed by one or more processors of an electronic device with a housing, a rotatable input device configured to rotate relative to the housing, and a display device, the one or more programs including instructions for: displaying, via the display device, an audio media user interface of an application that provides an audio output, the audio media user interface including a first graphical element at a first location on the audio media user interface adjacent to the rotatable input device, the first graphical element indicating a first volume level; detecting a rotation of the rotatable input device; in response to detecting a rotation of the rotatable input device, displaying a second graphical element on the audio media user interface, wherein: the second graphical element is different from the first graphical element, the second graphical element indicates a second volume level that is based on a magnitude of the rotation of the rotatable input device, and the second volume level is different from the first volume level; and after detecting that the rotation of the rotatable input device has ceased, displaying a third graphical element at the first location on the audio media user interface, wherein: the third graphical element indicates the second volume level; and the third graphical element is different from the second graphical element.

An example transitory computer-readable storage medium stores one or more programs configured to be executed by one or more processors of an electronic device with a housing, a rotatable input device configured to rotate relative to the housing, and a display device, the one or more programs including instructions for: displaying, via the display device, an audio media user interface of an application that provides an audio output, the audio media user interface including a first graphical element at a first location on the audio media user interface adjacent to the rotatable input device, the first graphical element indicating a first volume level; detecting a rotation of the rotatable input device; in response to detecting a rotation of the rotatable input device, displaying a second graphical element on the audio media user interface, wherein: the second graphical element is different from the first graphical element, the second graphical element indicates a second volume level that is based on a magnitude of the rotation of the rotatable input device, and the second volume level is different from the first volume level; and after detecting that the rotation of the rotatable input device has ceased, displaying a third graphical element at the first location on the audio media user interface, wherein: the third graphical element indicates the second volume level; and the third graphical element is different from the second graphical element.

An example device includes a housing, a rotatable input device configured to rotate relative to the housing; a display device; one or more processors; and memory storing one or more programs configured to be executed by the one or more processors, the one or more programs including instructions for: displaying, via the display device, an audio media user interface of an application that provides an audio output, the audio media user interface including a first graphical element at a first location on the audio media user interface adjacent to the rotatable input device, the first graphical element indicating a first volume level; detecting a rotation of the rotatable input device; in response to detecting a rotation of the rotatable input device, displaying a second graphical element on the audio media user interface, wherein: the second graphical element is different from the first graphical element, the second graphical element indicates a second volume level that is based on a magnitude of the rotation of the rotatable input device, and the second volume level is different from the first volume level; and after detecting that the rotation of the rotatable input device has ceased, displaying a third graphical element at the first location on the audio media user interface, wherein: the third graphical element indicates the second volume level; and the third graphical element is different from the second graphical element.

An example device includes a housing, a rotatable input device configured to rotate relative to the housing; a display device; and means for displaying, via the display device, an audio media user interface of an application that provides an audio output, the audio media user interface including a first graphical element at a first location on the audio media user interface adjacent to the rotatable input device, the first graphical element indicating a first volume level; means for detecting a rotation of the rotatable input device; means for, in response to detecting a rotation of the rotatable input device, displaying a second graphical element on the audio media user interface, wherein: the second graphical element is different from the first graphical element, the second graphical element indicates a second volume level that is based on a magnitude of the rotation of the rotatable input device, and the second volume level is different from the first volume level; and means for after detecting that the rotation of the rotatable input device has ceased, displaying a third graphical element at the first location on the audio media user interface, wherein: the third graphical element indicates the second volume level; and the third graphical element is different from the second graphical element.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling audio media, thereby increasing the effectiveness, efficiency, and user satisfaction with such devices. Such methods and interfaces may complement or replace other methods for controlling audio media.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6R illustrate exemplary user interfaces in accordance with some embodiments.

FIG. 7 illustrates an exemplary method in accordance with some embodiments.

FIG. 8 illustrates an exemplary method in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for controlling audio media. In some embodiments, a device provides an audio media user interface with a common layout for various types of audio media applications and audio media items. For example, a user interface for a first audio media application has the same layout as a user interface provided for a second audio media application, but different controls are provided for the first audio media application than for the second audio media application. In another example, a user interface for an audio media application playing a first type of audio media has the same layout as a user interface provided for when the audio media application is playing a second type of audio media application, but different controls are provided for the first audio media item than for the second audio media item. Providing a common layout for different applications and/or types of audio media items reduces the cognitive burden on a user of learning different layouts for different applications and types of media items. In some embodiments, an audio media user interface includes a volume level indicator displayed adjacent to an input device (e.g., a rotatable input device) to indicate that the input device can be used to adjust a volume level for an audio media application. In response to detecting input via the input device, a second volume level indicator is displayed, for example, to provide a more detailed indication of the volume level than the first volume level indicator as the volume is being adjusted. After detecting that the input has ceased, a third volume level indicator (e.g., an updated version of the first volume level indicator) is displayed to indicate the adjusted volume level. Such techniques can reduce the cognitive burden on a user who controlling audio media, thereby enhancing productivity. Further, such techniques can reduce processor and battery power otherwise wasted on redundant user inputs.

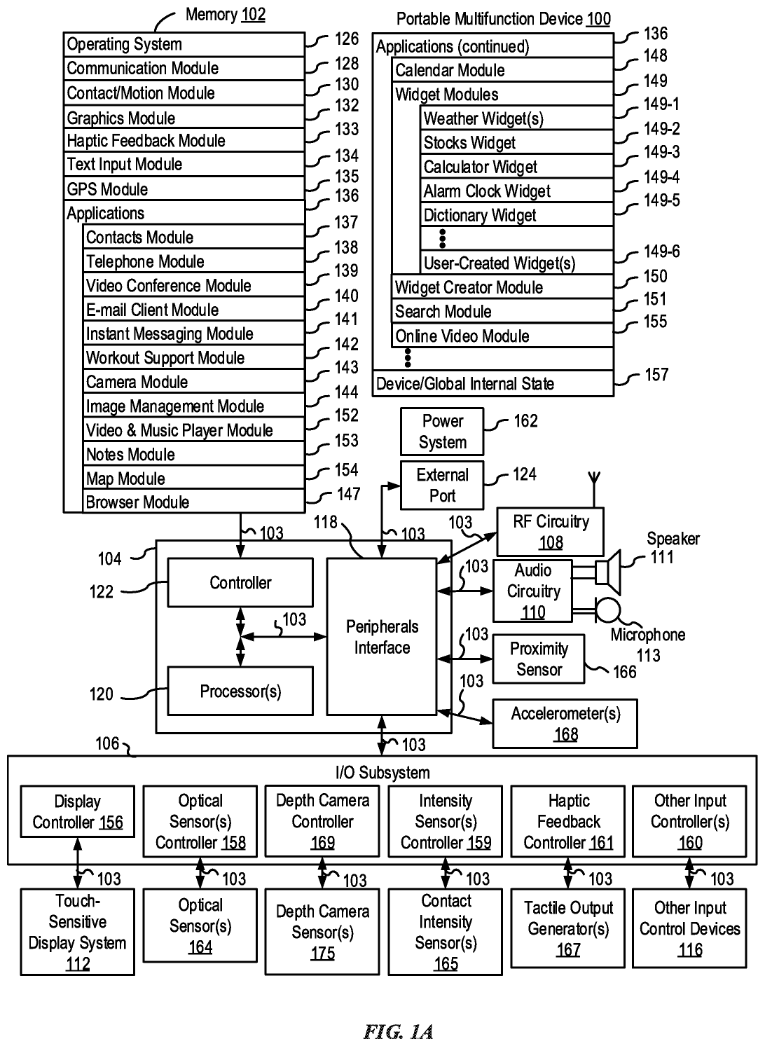

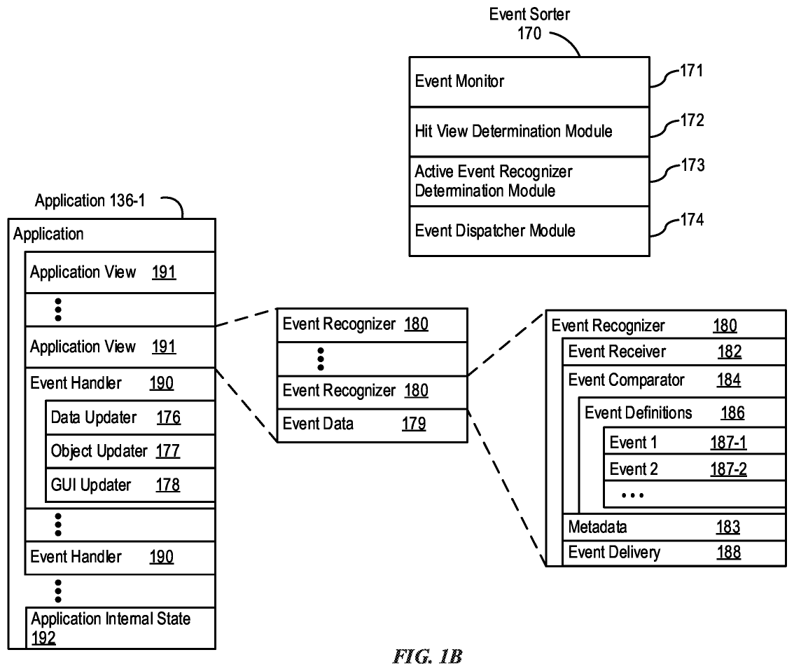

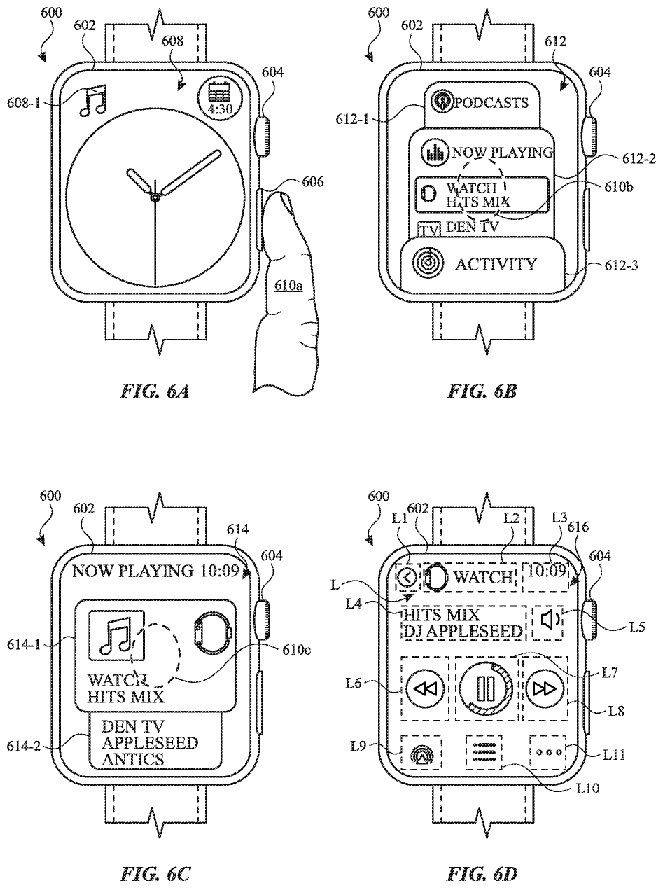

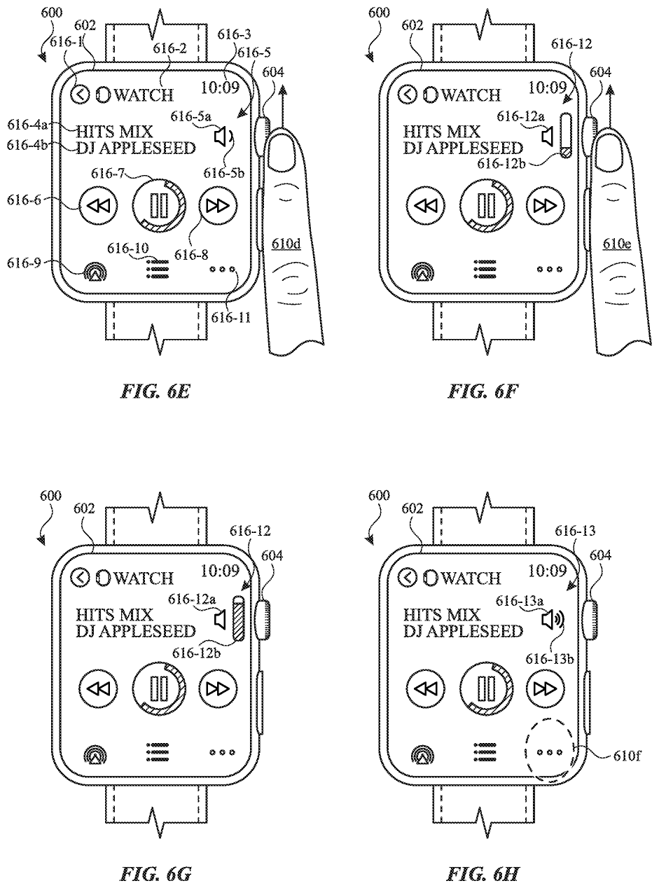

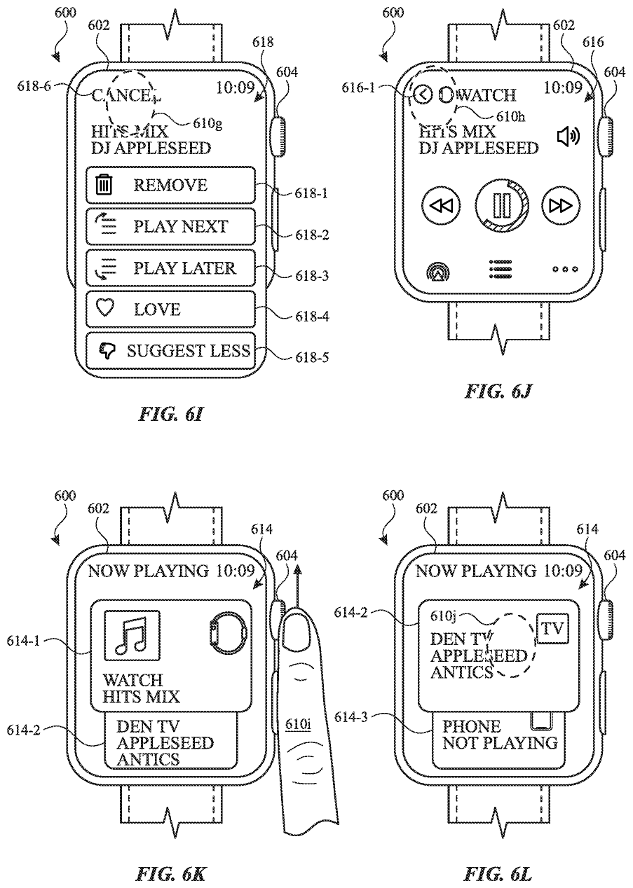

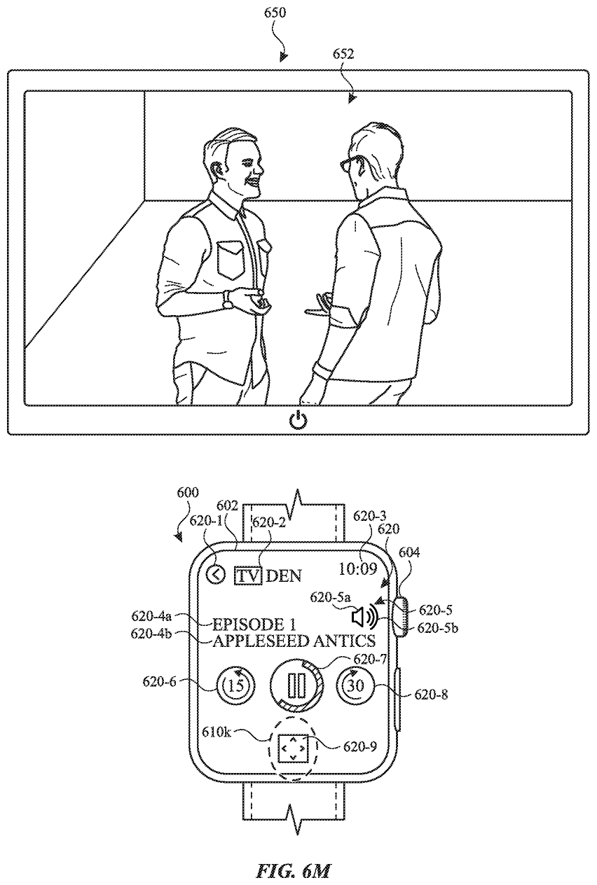

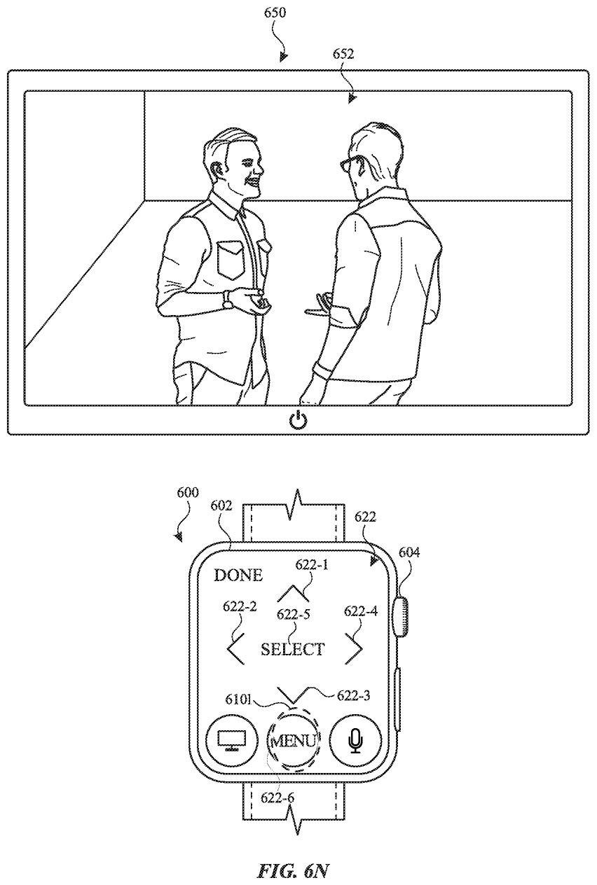

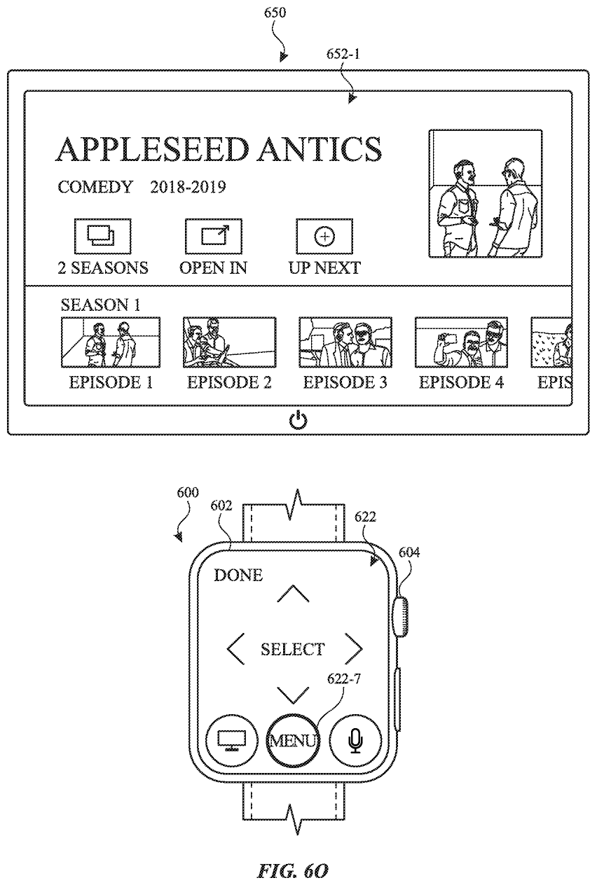

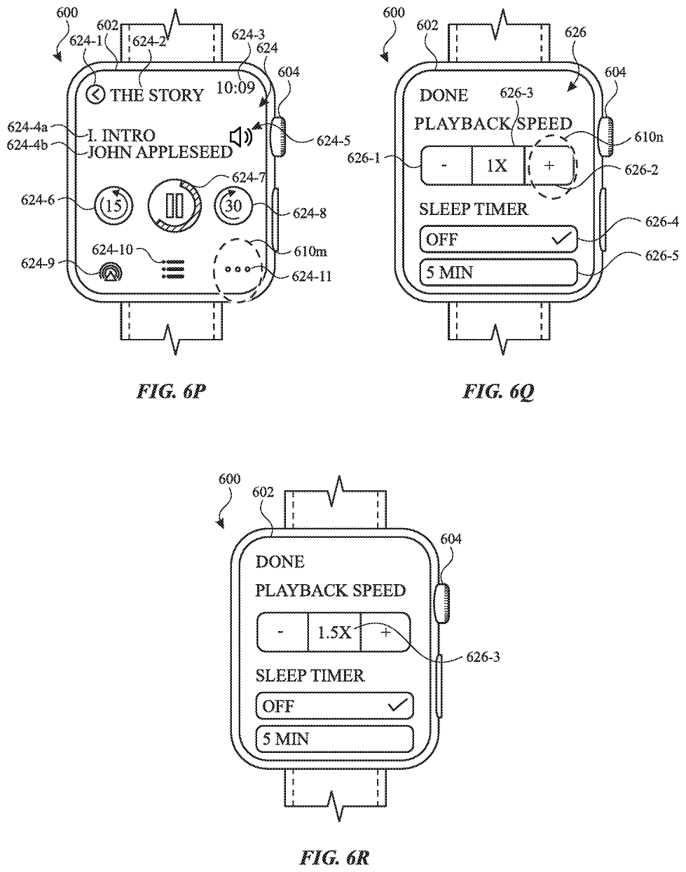

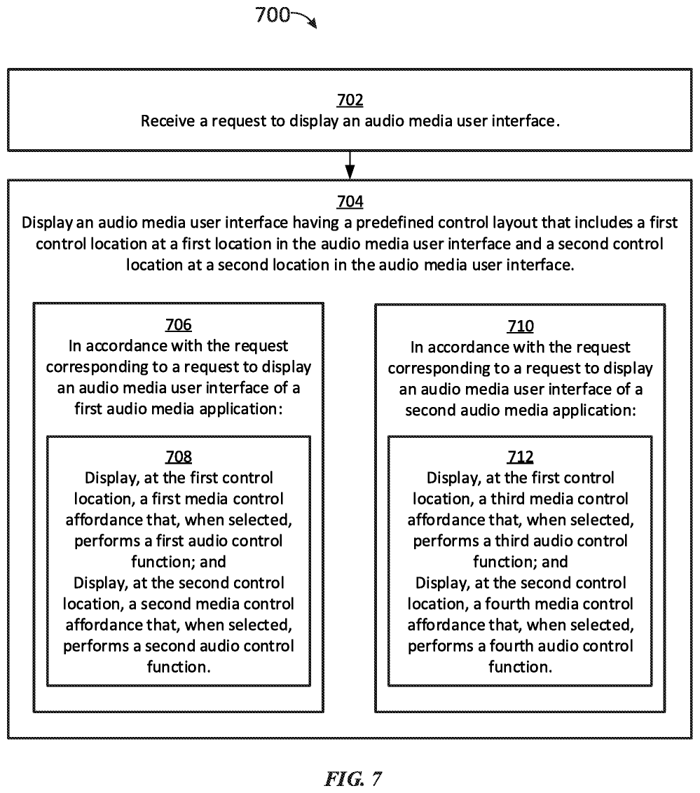

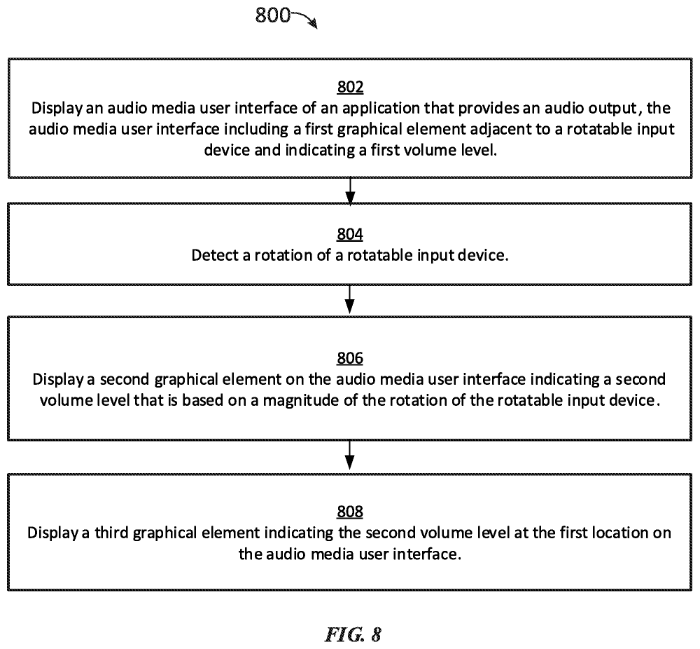

Below, FIGS. 1A-1B, 2, 3, 4A-4B, and 5A-5H provide a description of exemplary devices for performing the techniques for controlling audio media. FIGS. 6A-6R illustrate exemplary user interfaces for controlling audio media. FIG. 7 is a flow diagram illustrating methods of controlling audio media in accordance with some embodiments. The user interfaces in FIGS. 6A-6R are used to illustrate the processes described below, including the processes in FIGS. 7-8.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (110) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

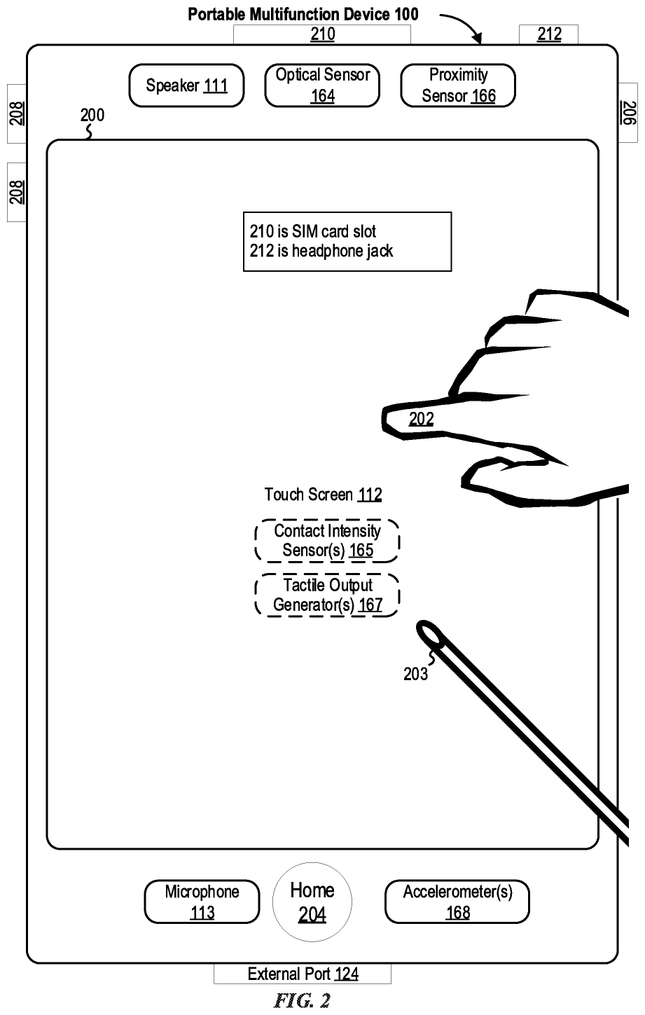

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

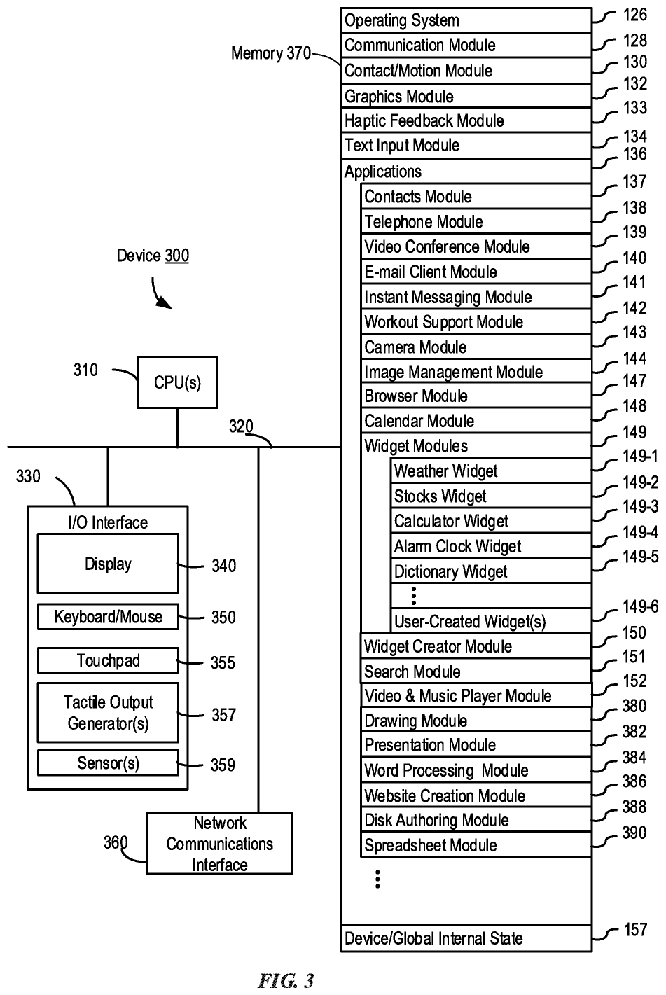

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs: and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. 1/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

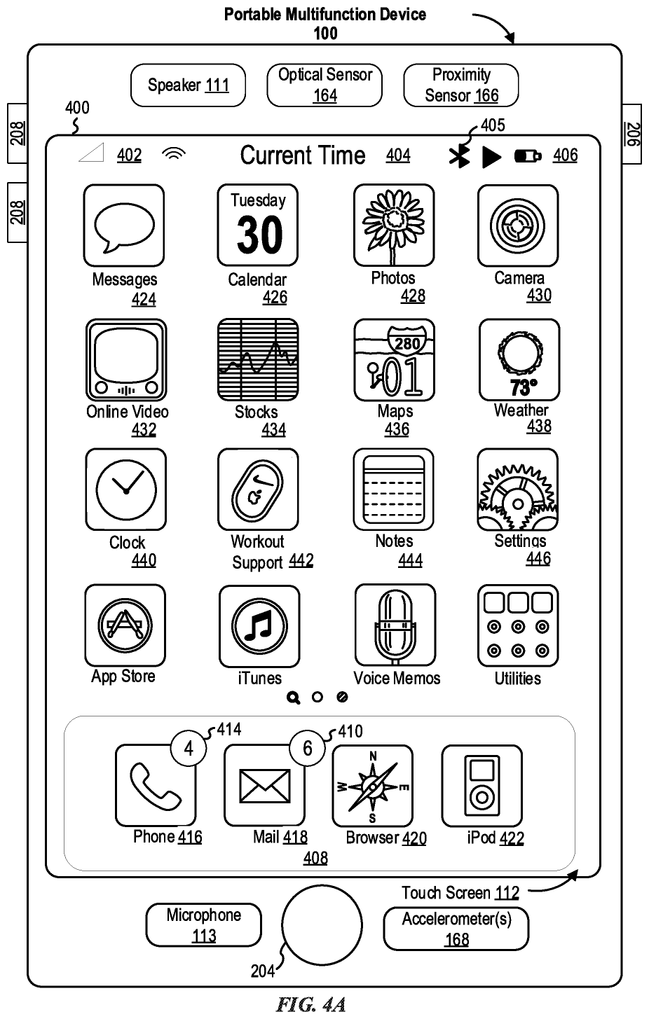

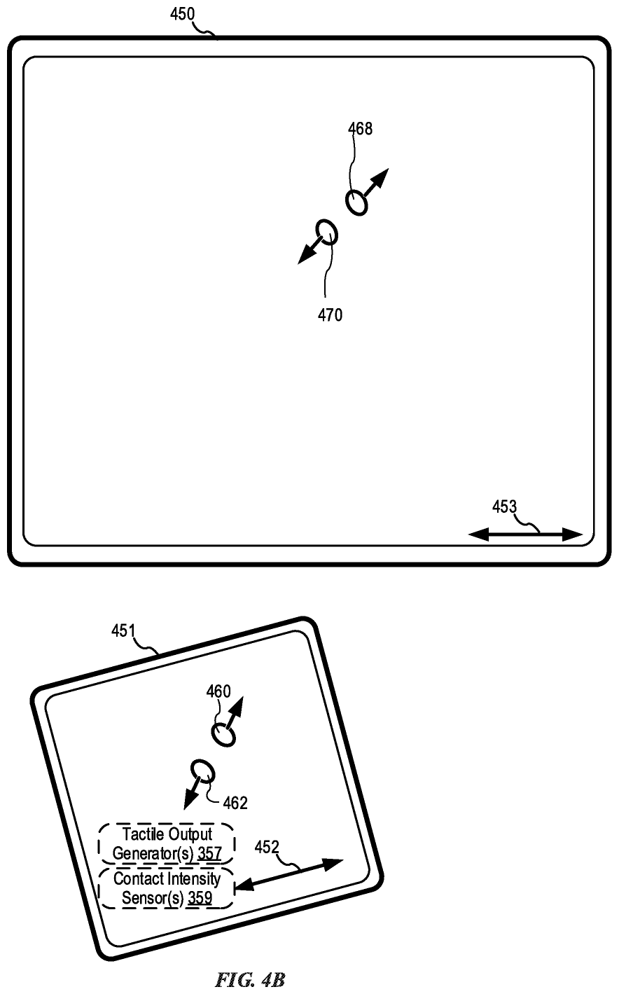

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser,” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

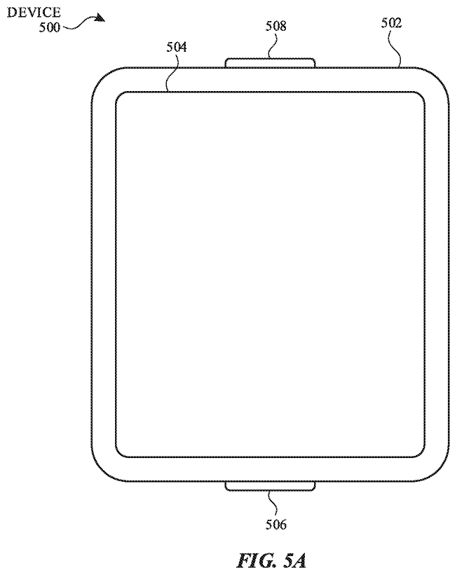

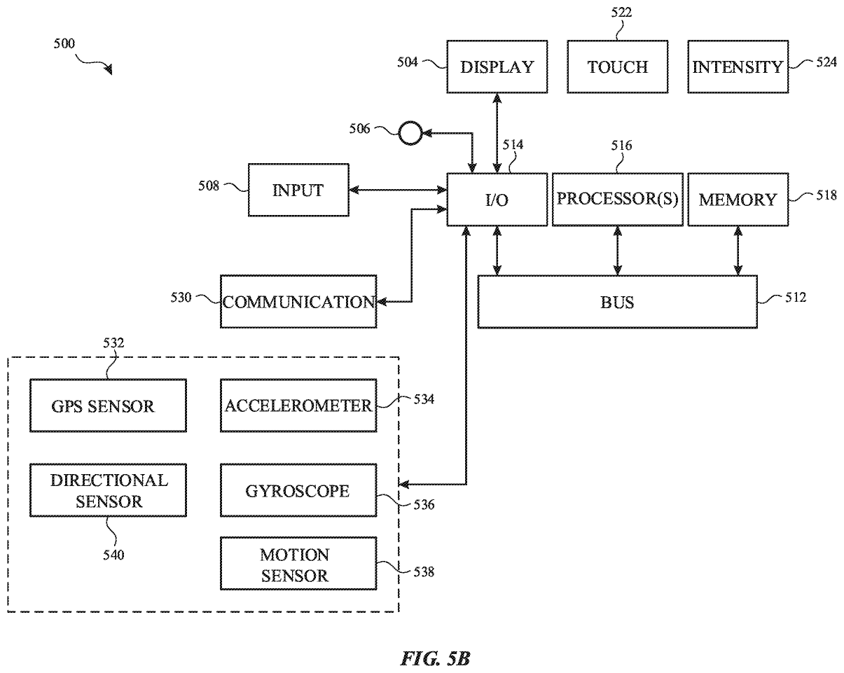

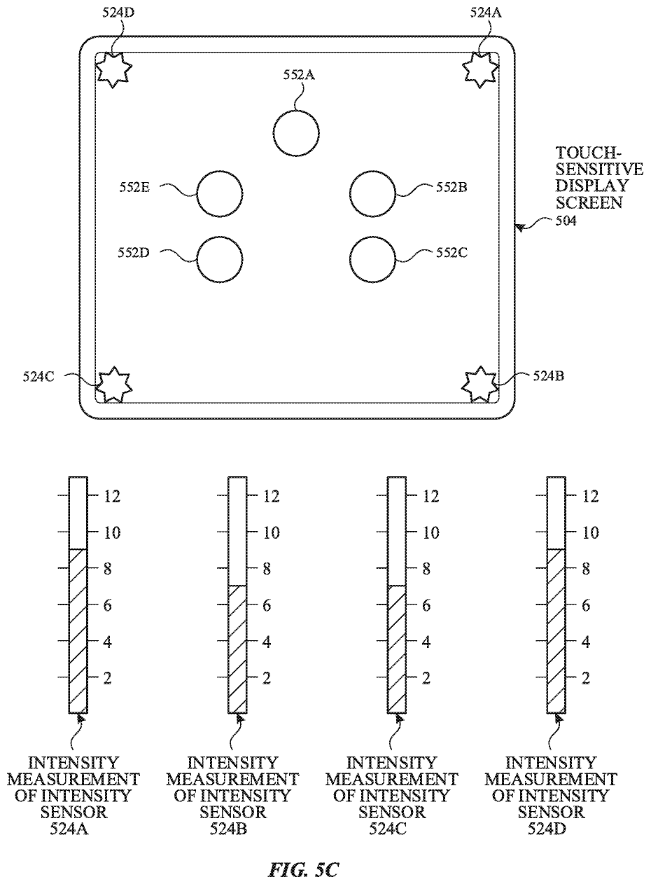

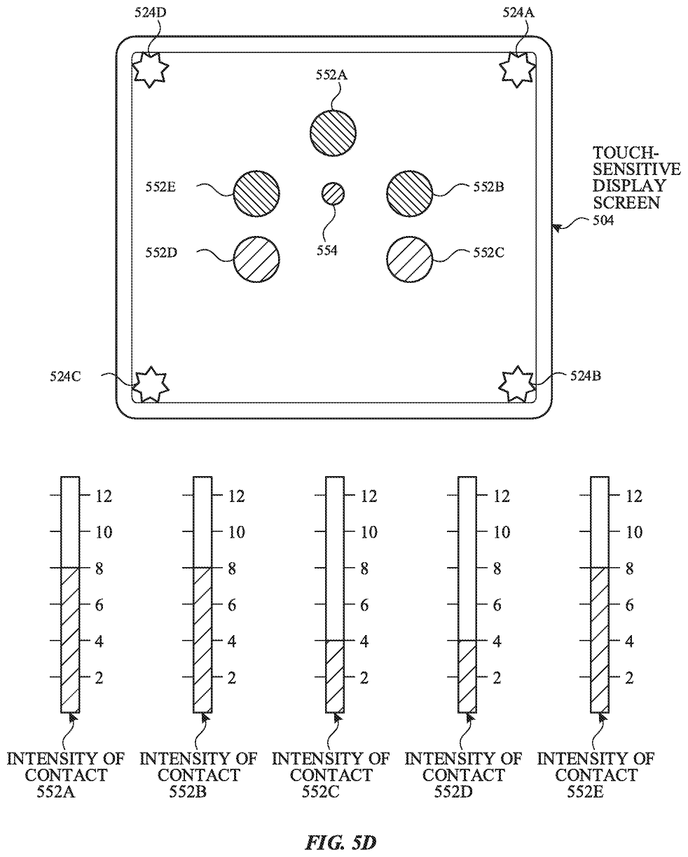

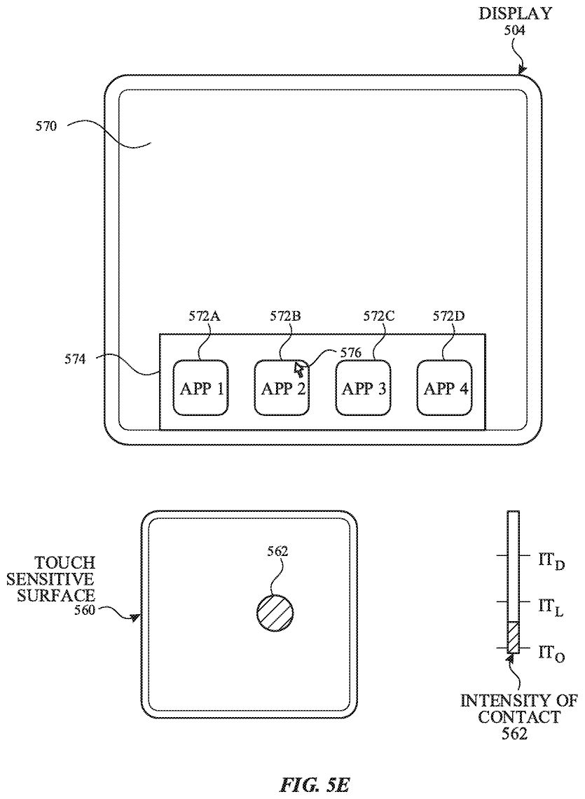

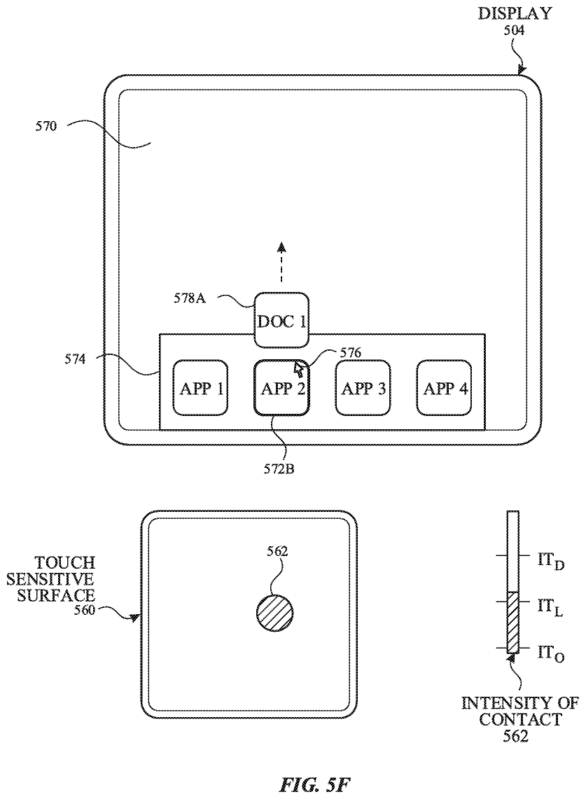

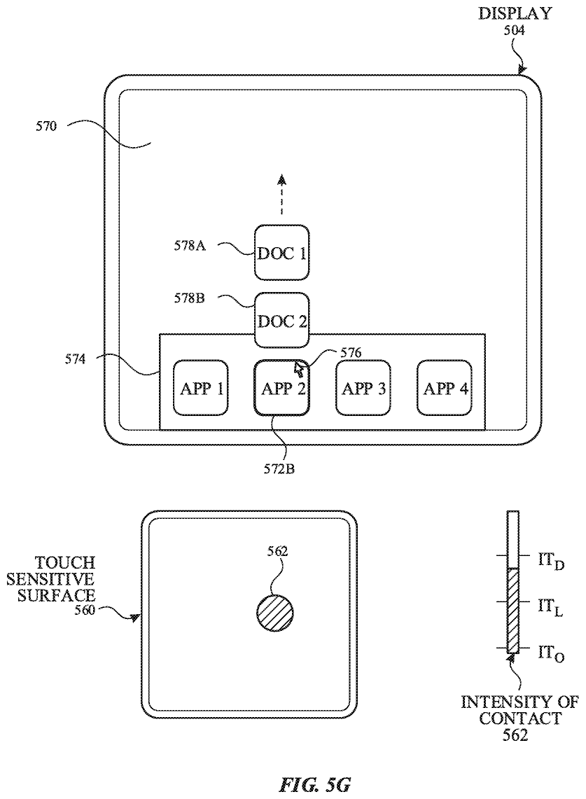

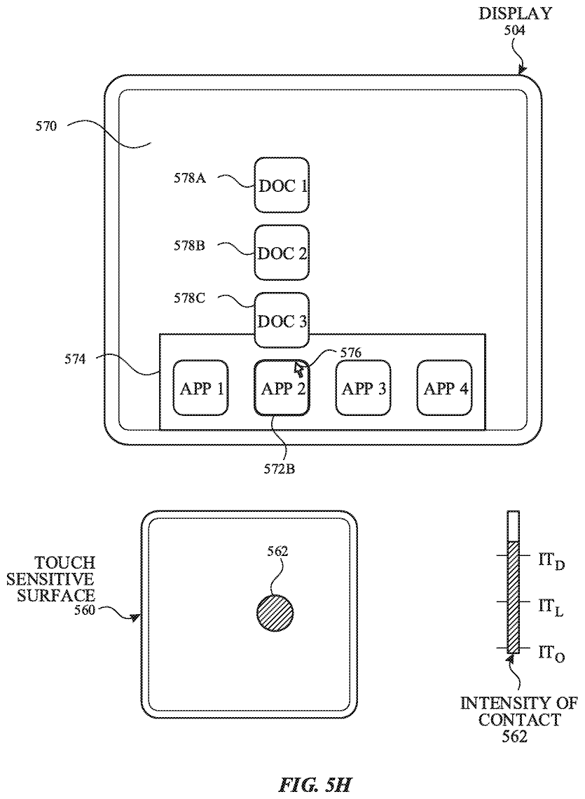

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including methods 700 and 800 (FIGS. 7 and 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“U”) and associated processes that are implemented on an electronic device, such as portable multifunction device 100, device 300, or device 500.

FIGS. 6A-6R illustrate exemplary user interfaces for controlling audio media and other related functions, in accordance with some embodiments. The user interfaces in these figures are used to illustrate the methods described below, including the methods in FIG. 7 and FIG. 8.

FIG. 6A illustrates device 600 (e.g., a watch). In some embodiments, device 600 is device 100, 300, or 500. Device 600 has a display device 602 depicted as a touch-sensitive display (e.g., touchscreen 504). Touch-sensitive display 602 is configured to detect the intensity of contacts. Exemplary components for detecting the intensity of contacts, as well as techniques for their detection, are described in greater detail above. Device 600 has a depressible and rotatable input device 604 configured to rotate relative to a frame or housing of device 600. In some embodiments, input device 604 is rotatable and not depressible. Depressible and rotatable input device 604 is configured to rotate about an axis that is parallel to the surface of touch-sensitive display 602. Device 600 includes mechanical button 606.

In FIG. 6A, device 600 displays user interface 608 (e.g., a clock face) and detects input 610a (e.g., a press of button 606). In response to detecting input 610a, device 600 displays user interface 612 (e.g., an application dock), as shown in FIG. 6B. User interface 612 includes affordances 612-1, 612-2, and 612-3 corresponding to respective applications. In FIG. 6B, device 600 detects input 610b corresponding to selection of affordance 612-2. In FIG. 6B, input 610b is a tap on affordance 612-2. In response to detecting input 610b, device 600 displays user interface 614, as shown in FIG. 6C. User interface 614 includes a plurality of graphical elements, including affordance 614-1 and affordance 614-2. Affordance 614-1 corresponds to a music application on device 600. Affordance 614-2 corresponds to a multimedia application on device 650 (described below with reference to FIGS. 6M-60).

In FIG. 6C, device 600 detects input 610c corresponding to selection of affordance 614-1. In response to detecting input 610c, device 600 displays audio media user interface 616 of the music application on device 600, as shown in FIG. 6D.

Audio media user interface 616 has a predefined control layout L that includes a plurality of control locations L1-L11 at respective locations in audio media user interface 616. The controls displayed at the control locations of layout L depend on the application, device, and/or media item associated with audio media user interface 616. As mentioned, audio media user interface 616 corresponds to a music application on device 600 that plays audio tracks (e.g., song tracks).

In accordance with audio media user interface 616 corresponding to a music application on device 600 that plays audio tracks, audio media user interface includes, inter alia, media control affordances 616-6 through 616-11 at locations L6-L11, respectively, as shown in FIG. 6E. Media control affordances 616-6 through 616-11, when selected, perform corresponding audio control functions previous track, play/pause, next track, display menu one, track list, and display menu 2, respectively.

In FIG. 6E, audio media user interface 616 includes graphical element 616-5 at location L5, adjacent to depressible and rotatable input device 604. Graphical element 616-5 includes sub-graphical element 616-5a (e.g., a graphical representation of a speaker) and sub-graphical element 616-5b (e.g., an audio wave). Graphical element 616-5 indicates a current volume level. In the embodiment illustrated in FIG. 6E, graphical element 616-5 can represent discrete volume levels (e.g., LOW, MEDIUM, HIGH, MUTE), as indicated by the number of arcs in sub-graphical element 616-5b. The single arc in sub-graphical element 616-5b indicates a volume level of LOW.

The location of graphical element 616-5 being next to depressible and rotatable input device 604 indicates to the user that depressible and rotatable input device 604 can be rotated to adjust the volume level. In FIG. 6E, device 600 detects input 610d (e.g., rotation of depressible and rotatable input device 604). In response to detecting input 610d, device 600 displays graphical element 616-12, including sub-graphical element 616-12a and sub-graphical element 616-12b. In the embodiment illustrated in FIG. 6F, sub-graphical element 616-12a is the same as sub-graphical element 616-5a, and sub-graphical element 616-12b replaces sub-graphical element 616-5b. Sub-graphical element 616-12b includes a fill bar, where the amount that the bar is filled indicates the current volume level. Initially, sub-graphical element 616-12b indicates the same volume level as sub-graphical element 616-5b, but to a finer level of precision (e.g., greater resolution). In FIG. 6F, device 600 detects input 610e (e.g., further rotation of depressible and rotatable input device 600; a continuation of input 610d). In response to input 610e, device 600 maintains the visual appearance of sub-graphical element 616-12b and updates the visual appearance of sub-graphical element 616-12b to indicate a new volume level that is based on the magnitude of input 610e (e.g., an amount of rotation of depressible and rotatable input device 604). Compared to FIG. 6F, the fill bar of sub-graphical element 616-12b in FIG. 6G has a greater amount of fill, indicating an increase in the volume level to a volume level corresponding to HIGH. Since sub-graphical element 616-12b has a volume resolution than, e.g., sub-graphical element 616-5b, there are various fill levels of sub-graphical element 616-12b that correspond to each of the discrete volume levels capable of being represented by graphical element 616-5.

In FIG. 6H, after detecting that input 610e has ceased, device 600 displays graphical element 616-13 at location L5 on audio media user interface 616. Graphical element 616-13 indicates a discrete volume level corresponding to the adjusted volume level represented by graphical element 616-12 in FIG. 6G. Graphical element 616-13 includes sub-graphical element 616-13a (which in the illustrated embodiment is the same as sub-graphical element 616-5a) and sub-graphical element 616-13b, which indicates a discrete volume level of HIGH, corresponding to the volume level represented by sub-graphical element 616-13b in FIG. 6G. In some embodiments, device 600 replaces graphical element 616-12 with graphical element 616-13 at a predetermined amount of time after detecting that input 610e has ceased.

In FIG. 6H, device 600 detects input 610f (e.g., a tap) corresponding to selection of media control affordance 616-11. In response to detecting input 610f, device 600 displays user interface 618, shown in FIG. 6I. User interface 618 is an options menu corresponding to the application and/or media item associated with audio media user interface 616. That is, the features of user interface 618 are based on the application and/or media item associated with audio media user interface 616. For the music application and the audio track of audio media user interface 616, options menu user interface 618 includes affordances 618-1 through 618-5 that, when selected, perform the functions remove, play next, play later, love, and suggest less, respectively.

In FIG. 6I, device 600 detects input 610g (e.g., a tap) corresponding to selection of cancel affordance 618-6. In response to detecting input 610g, device 600 returns to (e.g., displays) audio media user interface 616, as shown in FIG. 6J. In FIG. 6J, device 600 detects input 610h (e.g., a tap) corresponding to selection of back affordance 616-1. In response to detecting input 610h, device 600 returns to (e.g., displays) user interface 614, as shown in FIG. 6K. In FIG. 6K, device 600 detects input 610i (e.g., rotation of depressible and rotatable input device 604). In response to detecting input 610i, device 600 scrolls user interface 614, as shown in FIG. 6L. In the embodiment illustrated in FIG. 6L, scrolling user interface 614 includes: (1) scrolling affordance 614-1 off display 602 (e.g., device 600 ceases display of affordance 614-1, e.g., by moving affordance 614-1 into the background behind affordance 614-2 or off an edge of user interface 614); (2) moving affordance 614-2 into a central position on user interface 614; and (3) displaying previously hidden affordance 614-3.

In FIG. 6L device 600 detects input 610j (e.g., a tap) corresponding to selection of affordance 614-2. In response to detecting input 610j, device 600 displays audio media user interface 620 corresponding to multimedia application 652 displayed on device 650, as shown in FIG. 6M. In some embodiments, multimedia application 652 (e.g., an audio/video streaming and/or playback application) is running on device 650 (e.g., a network-enabled television in communication with device 600). In some embodiments, multimedia application 652 is running on a multimedia hub device that provides audio and video data to device 650.

Audio media user interface 620 has layout L (e.g., the same layout as audio media user interface 616) with media control affordances 620-6 through 620-9 for multimedia application 652 and device 650 at control locations L6, L7, L8, and L10, respectively. In contrast to audio media user interface 616, audio media user interface 620 has, inter alia: (1) media control affordance 620-6 at location L6 that, when selected, performs a skip backward function (e.g., skip backward 15 seconds); (2) media control affordance 620-8 at location L8 that, when selected, performs a skip forward function (e.g., skip forward 30 seconds); (3) media control affordance 620-9 at location L10 that, when selected, provides a remote control user interface (described below with reference to FIGS. 6N-60); and (4) no media control affordances at location L9 and location L11.

In FIG. 6M, device 600 detects input 610k (e.g., a tap) corresponding to selection of media control affordance 620-9. In response to detecting input 610k, device 600 displays remote control user interface 622, as shown in FIG. 6N. Remote control user interface 622 includes a plurality of directional affordances 622-1 through 622-4 that, when selected, transmit respective directional command signals to device 650 to perform respective directional functions, and select affordance 622-5 that, when selected, transmits a selection command signal to device 650 to perform a selection function. In some embodiments, rather than transmitting signals to device 650, device 600 transmits signals to a device (e.g., a multimedia hub device) that provides application 652 displayed on device 650.

As shown in FIG. 6N, remote control user interface 622 includes menu affordance 622-6, and device 600 detects input 610l (e.g., a tap) corresponding to selection of menu affordance 622-6. In response to detecting input 610l, device 600 transmits a command (e.g., to device 650) for multimedia application 652 to display menu user interface 652-1, as shown in FIG. 6O. In some embodiments, device 600 displays a visual indication (e.g., emphasis ring 622-7) on remote control user interface 622 to indicate a state of multimedia application 652 and/or device 650 (e.g., that menu user interface 652-1 is displayed on device 650). While menu user interface 652-1 is displayed on device 650, affordances 622-1 through 622-5 can be selected on user interface 622 of device 600 to navigate menu user interface 652-1 on device 650.

Turning to FIGS. 6P-6R, an audio media user interface for an audio book application is described. In FIG. 6P, device 600 displays audio media user interface 624 corresponding to an audio book application. In some embodiments, audio media user interface 624 corresponds to a multimedia application playing an audio book. Audio media user interface 624 has layout L (e.g., the same layout as audio media user interface 616 and audio media user interface 620) and, inter alia, media control affordances 624-6 through 624-11 corresponding to the audio book application. In contrast to audio media user interface 616, audio media user interface 624 has, inter alia: (1) media control affordance 624-6 at location L6 that, when selected, performs a skip backward function (e.g., skip backward 15 seconds); and (2) media control affordance 624-8 at location L8 that, when selected, performs a skip forward function (e.g., skip forward 30 seconds). In contrast to audio media user interface 620, audio media user interface 624 has, inter alia: (1) media control affordance 624-9 at location L9 (which is unoccupied in audio media user interface 620); (2) media control affordance 624-11 at location L11 (which is unoccupied in audio media user interface 620); and (3) media control affordance 624-10 at L10 that, when selected, displays a list of chapters for the audio book (instead of remote control affordance 620-9).

In FIG. 6P, device 600 detects input 610m (e.g., a tap) corresponding to selection of media control affordance 624-11. Similar to media control affordance 616-11 in audio media user interface 616, media control affordance 624-11, when selected, causes display of a menu user interface. However, in contrast to menu user interface 618 displayed in response to selection of media control affordance 616-11 in audio media user interface 616, selection of media control affordance 624-11 causes display of menu user interface 626, as shown in FIG. 6Q. Menu user interface 626 includes options corresponding to the audio book application associated with audio media user interface 624. In the embodiment illustrated in FIG. 6Q, menu user interface 626 includes affordance 626-1 and affordance 626-2 that, when selected, decrease and increase, respectively, the playback speed of the audio book being played by the audio book application of audio media user interface 624. Graphical element 626-3 indicates the currently selected playback speed. In FIG. 6Q, device 600 detects input 610n (e.g., a tap) corresponding to selection of affordance 626-2. In response to detecting input 610n, device 600 changes the playback speed from 1× to 1.5× (e.g., one and a half times a normal speed), as indicated by element 626-3 in FIG. 6R.

Menu user interface 626 includes affordance 626-4 and affordance 626-5 that, when selected, set a respective time for a sleep timer. For example, in response to selection of affordance 626-5 (e.g., a tap on affordance 626-5), device 600 changes the sleep timer from an off state (as indicated in FIGS. 6Q-6R) to a setting of 5 minutes, and moves the check mark from affordance 626-4 to a corresponding location on affordance 626-5. In some embodiments, the time selected for the sleep timer causes device 600 to cease playing the audio book at a time determined based on the selected sleep timer setting (e.g., 5 minutes after the sleep timer is set).

FIG. 7 is a flow diagram illustrating a method for controlling audio media using an electronic device in accordance with some embodiments. Method 700 is performed at a device (e.g., 100, 300, 500, or 600) with a display device (e.g., 602). In some embodiments, the device is a watch (e.g., a smartwatch) with a touch-sensitive display. Some operations in method 700 are, optionally, combined, the orders of some operations are, optionally, changed, and some operations are, optionally, omitted.

As described below, method 700 provides an intuitive way for controlling audio media. The method reduces the cognitive burden on a user for controlling audio media, thereby creating a more efficient human-machine interface. For battery-operated computing devices, enabling a user to controlling audio media faster and more efficiently conserves power and increases the time between battery charges.

In some embodiments, the electronic device (e.g., 600) receives (702) a request to display an audio media user interface. In some embodiments, the request is a wrist raise gesture, a contact on the touch-sensitive display, a press of the rotatable and depressible input device, a press of the side button, selection of an affordance corresponding to an audio media control application, etc. In some embodiments, the request is a request to display a graphical user interface for controlling an audio media application running on the electronic device or an audio media application running on an external device in communication (e.g., paired with) the electronic device. Types of audio media include, but are not limited to, audio tracks, podcasts, audio books, streaming audio, video (recorded or streaming) that includes audio, etc.

In some embodiments, in response to receiving the request to display an audio media user interface, the electronic device displays (704), via the display device (e.g., 602), an audio media user interface (e.g., 616) having a predefined control layout (e.g., L) that includes a first control location (e.g., L6) at a first location in the audio media user interface and a second control location (e.g., L8) at a second location in the audio media user interface (e.g., the audio media user interface includes controls such as play, pause, stop, fast forward, rewind, next track, previous track/restart current track). In some embodiments, a control location includes an affordance that, when selected, causes the electronic device to display additional controls or menu options for the audio media provided by the audio media application. Displaying an audio media user interface with a predefined control layout can provide a consistent, predictable, and familiar arrangement so that a user can easily locate controls for operating an audio media application. Providing a consistent, predictable, and familiar arrangement of media controls enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the predefined control layout includes a fourth control location (e.g., L11) at a fourth location in the audio media user interface. In some embodiments, displaying the audio media user interface includes displaying, at the fourth control location, an options affordance (e.g., 616-11). In some embodiments, the fourth control location is in a bottom corner of the audio media user interface (e.g., the bottom right corner). In some embodiments, the electronic device detects an input (e.g., 610f, 610m) corresponding to selection of the options affordance. In some embodiments, in response to detecting the input corresponding to selection of the options affordance, in accordance with the audio media user interface corresponding to a third audio media application (e.g., the first audio media application or the second audio media application), the electronic device displays a first user interface (e.g., 626) including a first plurality of graphical elements; and in response to detecting the input corresponding to selection of the options affordance, in accordance with the audio media user interface corresponding to a fourth audio media application different from the third audio media application (e.g., the other one of the first audio media application and the second audio media application that is not the third audio media application), the electronic device displays a second user interface (e.g., 618) including a second plurality of graphical elements. Displaying different user interfaces in response to selection of the options affordance based on the audio media application associated with audio media user interface provides the user with relevant visual feedback by presenting graphical elements (e.g., additional controls or menu options) that are related to the particular audio media application associated with audio media user interface. This feature also displays a particular user interface when a set of conditions has been met (e.g., the audio media user interface is associated with a particular audio media application or item) without requiring further user input to access relevant controls or options. Providing improved visual feedback to the user and performing an operation when a set of conditions has been met without requiring further user input enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the first plurality of graphical elements includes one or more affordances (e.g., 626-1, 626-2) that, when selected, adjust a playback speed of audio of the third audio media application. In some embodiments, if the audio media user interface corresponds to an audio media application that provides podcast or audiobook audio, then affordances for adjusting the playback speed (e.g., 0.5×, 1×, 1.5×, 2×) of the podcast or audiobook are displayed, whereas if the audio media user interface corresponds to an audio media application that provides music track audio, then affordances for functions related to a current track are displayed (e.g., remove track, play next, play later, designate (e.g., as a favorite), suggest less).

In some embodiments, the first plurality of graphical elements includes one or more affordances (e.g., 626-4, 626-5) that, when selected, set a threshold time duration (e.g., 5 minutes, 10 minutes). In some embodiments, the third audio media application is configured to cease playing audio at a first time that is based on the threshold time duration (e.g., a time that is the threshold time duration after the time duration is set; a time that is the threshold time duration after a last input is received after the time duration is set; a time that is the threshold time duration after an audio media item has been started).

In some embodiments, as part of displaying the audio media user interface, in accordance with (706) the request corresponding to a request to display an audio media user interface of a first audio media application (e.g., a music application; a multimedia application that includes an audio component), the electronic device displays (708), at the first control location, a first media control affordance (e.g., 616-6) that, when selected, performs a first audio control function (e.g., the user interface for a music application includes a previous track affordance to skip to a previous track in a location to the left of a centrally-located play/pause affordance).

In some embodiments, as part of displaying the audio media user interface, in accordance with (706) the request corresponding to a request to display an audio media user interface of a first audio media application (e.g., a music application; a multimedia application that includes an audio component), the electronic device displays (708), at the second control location, a second media control affordance (e.g., 616-8) that, when selected, performs a second audio control function (e.g., the user interface for a music application includes a next track affordance to skip to a next audio track in a location to the left of the play/pause affordance).

In some embodiments, as part of displaying the audio media user interface, in accordance with (710) the request corresponding to a request to display an audio media user interface of a second audio media application (e.g., a podcast application or an audiobook application), the electronic device displays (712), at the first control location, a third media control affordance (e.g., 624-6) that, when selected, performs a third audio control function, different from the first audio control function (e.g., the user interface for a podcast application includes a rewind affordance in the location to the left of the play/pause affordance).

In some embodiments, as part of displaying the audio media user interface, in accordance with (710) the request corresponding to a request to display an audio media user interface of a second audio media application (e.g., a podcast application or an audiobook application), the electronic device displays (712), at the second control location, a fourth media control affordance (e.g., 624-8) that, when selected, performs a fourth audio control function, different from the second audio control function (e.g., the user interface for the podcast application includes a fast forward affordance in the location to the left of the play/pause affordance). In some embodiments, an application can play different types of audio media (e.g., audio tracks and podcasts). In some such embodiments, the audio media user interface has the same predefined layout for different types of media, but includes different controls depending on the type of media played by the application (e.g., the audio media user interface for a single application can have different control based on the type of media item presented by the application). In some embodiments, the audio media user interface has the same predefined layout for applications on different devices, but includes different controls depending on the device (e.g., the user interface includes different controls for a music application running on a smartphone than for a music application running on a multi-media device, such as Apple TV). Displaying different media control affordances on the audio media user interface based on the audio media application associated with audio media user interface provides the user with relevant visual feedback by presenting controls that are related to the particular audio media application associated with audio media user interface. This feature also displays particular controls when a set of conditions has been met (e.g., the audio media user interface is associated with a particular audio media application or item) without requiring further user input to access relevant controls. Providing improved visual feedback to the user and performing an operation when a set of conditions has been met without requiring further user input enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the first audio control function includes skipping to a next audio track. In some embodiments, selection of the first media control affordance for more than a threshold duration of time performs a fast forward function that is based on the duration of the selection of the first media control affordance. In some embodiments, the second audio control function includes skipping to a previous audio track. In some embodiments, skipping to a previous audio track include skipping to a previous portion (e.g., the beginning) of a current audio track. In some embodiments, selection of the second media control affordance for more than a threshold duration of time performs a rewind function that is based on the duration of the selection of the second media control affordance. In some embodiments, the third audio control function includes skipping forward a predefined amount of time (e.g., 30 seconds) within a current track (e.g., skipping directly to a subsequent position of the current track without fast forwarding through the intervening portions of the current track). In some embodiments, the fourth audio control function includes skipping backward a predefined amount of time (e.g., 15 seconds) within a current track (e.g., skipping directly to a previous position of the current track without rewinding through the intervening portions of the current track).

In some embodiments, the predefined control layout includes a third control location (e.g., L10) at a third location in the audio media user interface (e.g., a location in the center of a bottom row of locations). In some embodiments, the third control location is below a play/pause control that is located near the center of the audio media user interface. In some embodiments, as part of displaying the audio media user interface, in accordance with the audio media user interface being configured to control one or more audio media functions of a first external device (e.g., 650; a multimedia hub device), the electronic device displays, at the third control location, a remote control interface affordance (e.g., 620-9). In some embodiments, the audio media user interface is configured to control functions of an external device by including one or more affordances that, when selected, causes transmission of a control signal to an external device. In some embodiments, as part of displaying the audio media user interface, in accordance with the audio media user interface being configured to control one or more audio media functions of a second external device (e.g., a phone or wireless speaker; an external device different from the first external device), the electronic device forgoes displaying the remote control interface affordance at the third control location. In some embodiments, while displaying the remote control interface affordance, the electronic device receives a first input (e.g., 610k) corresponding to selection of the remote control interface affordance. In some embodiments, in response to receiving the first input, the electronic device displays a remote control user interface (e.g., 622) that includes a first remote function affordance (e.g., 622-1, 622-2, 622-3, 622-4, 622-5, 622-6) that, when selected, transmits a command signal to the first external device to perform a first remote function. In some embodiments, the remote function affects one or more non-audio features of the first external device in addition to audio features of the first external device (e.g., the first remote function is an audio function and graphical display function of the first external device). Displaying a remote control user interface when the audio media user interface is configured to control one or more audio media functions of a first external device provides the user with improved visual feedback by displaying controls that would otherwise require a separate remote control. This feature also displays particular controls when a set of conditions has been met without requiring further user input to access relevant controls. Providing improved visual feedback to the user and performing an operation when a set of conditions has been met without requiring further user input enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the first remote function is a graphical display function (e.g., a graphical display navigation function) of the first external device. Graphical display functions include, but are not limited to, changing the focus of a graphical user interface (e.g., selecting a graphical element by moving highlighting from one graphical element to another) and displaying a graphical menu (e.g., 652-1).

In some embodiments, the remote control user interface includes a plurality of directional affordances (e.g., 622-1, 622-2, 622-3, 622-4, 622-5) that, when selected, transmit respective directional command signals to the first external device (e.g., 650) to perform respective directional functions and a select affordance that, when selected, transmits a selection command signal to the first external device to perform a selection function. In some embodiments, the directional and/or selection command signals are sent directly to the first external device from the electronic device (e.g., via a Bluetooth connection). In some embodiments, the directional and/or selection command signals are sent indirectly from the electronic device to the first external device (e.g., via a common network connection. In some embodiments, selection of one of the directional affordances causes the electronic device to send instructions for the first external device to invoke a graphical display function corresponding to the directional input (e.g., move focus on a graphical user interface in the selected direction). In some embodiments, selection of the select affordances causes the electronic device to send instructions for the first external device to select a feature (e.g., an in-focus element) of a graphical user interface provided by the first external device.

In some embodiments, the remote control user interface includes a menu affordance (e.g., 622-6) that, when selected, transmits a menu command signal to the first external device to provide a graphical menu (e.g., 652-1; the first external device provides the menu for display on an external or integrated display).

In some embodiments, before receiving the request to display an audio media user interface, the electronic device displays, via the display device, a plurality of graphical elements including a first affordance (e.g., 614-1) that, when selected, causes display of an audio media user interface of an audio media application of a second device (e.g., the electronic device, another device) and a second affordance (e.g., 614-2) that, when selected, causes display of an audio media user interface of an audio media application of a third device different from the second device. In some embodiments, the electronic device is in communication (e.g., directly or indirectly) with one or more devices (e.g., a phone, watch, wireless speaker, television, multi-media streaming device (e.g., Apple TV, Amazon Fire TV Stick)) that are capable of running an audio media application. For example, the plurality of graphical elements includes a selectable platter corresponding to an audio media application running on the electronic device, another selectable platter corresponding to an audio media application running on a phone paired with the electronic device, and a web-enabled multi-media streaming device associated with a common user account as the electronic device. In some embodiments, the request to display an audio media user interface includes a selection (e.g., 610c) of the first affordance or the second affordance.

In some embodiments, as part of displaying the plurality of graphical elements, the electronic device displays the first affordance and the second affordance with the first affordance fully displayed and the second affordance at least partially hidden. In some embodiments, the affordances have a z-order (e.g., a front to back order) and the first affordance is displayed in front (or on top) of the second affordance and obscures at least part of the second affordance. In some embodiments, the affordances are positioned side-by-side, with the first affordance fully displayed in the center of the display and the second affordance partially or completely off an edge of the display. In some embodiments, the affordances are scrolled in response to detecting rotation of a rotatable input device. In some embodiments, scrolling the affordances includes moving the first affordance partially or completely off the display, displaying the entire second affordance, and, optionally, displaying at least a portion of a third affordance corresponding to an audio media application on a fifth device.

In some embodiments, as part of displaying the plurality of graphical elements, in accordance with a set of functions of the third device being available for control via the electronic device (e.g., the electronic device can provide an interface for controlling additional (e.g., non-audio) features of the third device), the electronic device displays the first affordance with a graphical feature (e.g., text) including a first visual characteristic. In some embodiments, the first affordance indicates that the electronic device provides remote control capability for the third device via a color scheme. For example, the graphical feature is displayed in a first color (e.g., pink). In some embodiments, as part of displaying the plurality of graphical elements, in accordance with the set of functions of the third device not being available for control via the electronic device (e.g., the electronic device can only control the audio functions provided on the audio media user interface), the electronic device displays the first affordance with the graphical feature including a second visual characteristic different from the first visual characteristic (e.g., the graphical feature has a different color, such as blue instead of pink). Displaying the first affordance with a graphical feature including a visual characteristic that is based on whether a set of functions of the third device is available for control via the electronic device provides the user with improved visual feedback by distinguishing the first affordance compared to affordances for devices for which the set of functions is not available for control via the electronic device. Providing improved visual feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

Note that details of the processes described above with respect to method 700 (e.g., FIG. 7) are also applicable in an analogous manner to the methods described below. For example, method 800 optionally includes one or more of the characteristics of the various methods described above with reference to method 700. For example, operation 702, 704, 706, 708, 710, and/or 712 of method 700 can be used to display the audio media user interface in operation 802 of method 800 with a predefined control layout. For brevity, these details are not repeated below.

FIG. 8 is a flow diagram illustrating a method for controlling audio media using an electronic device in accordance with some embodiments. Method 800 is performed at a device (e.g., 100, 300, 500, or 600) with a housing, a rotatable input device (e.g., 604) configured to rotate relative to the housing, and a display device (e.g., 602). Some operations in method 800 are, optionally, combined, the orders of some operations are, optionally, changed, and some operations are, optionally, omitted.

As described below, method 800 provides an intuitive way for controlling audio media. The method reduces the cognitive burden on a user for controlling audio media, thereby creating a more efficient human-machine interface. For battery-operated computing devices, enabling a user to controlling audio media faster and more efficiently conserves power and increases the time between battery charges.

In some embodiments, the electronic device (e.g., 600) displays (802), via the display device (e.g., 602), an audio media user interface (e.g., 616) of an application that provides an audio output. In some embodiments, the audio media user interface is for controlling an audio media application running on the electronic device or an audio media application running on an external device in communication (e.g., paired with) the electronic device. In some embodiments, the audio media includes audio tracks, podcasts, streaming audio, video (recorded or streaming) that includes audio, etc.). In some embodiments, the audio media user interface includes a first graphical element (e.g., 616-5) at a first location (e.g., L5) on the audio media user interface adjacent to the rotatable input device (e.g., 604). In some embodiments, the first graphical element indicates a first volume level. In some embodiments, the first graphical element indicates volume level by a number of arcs next to a representation of a speaker (e.g., zero arcs represents a mute state, one arc represents a low volume level, two arcs represents a medium volume level, and three arcs represents a high volume level). Displaying a graphical element indicating a volume level at a location on the audio media user interface adjacent to the rotatable input device provides the user with improved visual feedback by indicating that the rotatable input device can be used to adjust a volume level while also indicating the current volume level. Providing improved visual feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the electronic device detects (804) a rotation of the rotatable input device.

In some embodiments, in response to detecting a rotation (e.g., 610e) of the rotatable input device, the electronic device displays (806) a second graphical element (e.g., 616-12) on the audio media user interface (e.g., a slider (or bar), where the amount of the slider that is filled indicates the volume level; e.g., a numerical value indicating the volume level. In some embodiments, the second graphical element provides a finer indication of volume level compared to the first graphical element.). In some embodiments, the second graphical element is different from the first graphical element. Displaying a second graphical element that is different from the first graphical element in response to detecting a rotation of the rotatable input device provides the user with improved visual feedback by displaying a volume indicator that, for example, provides more detailed information during volume adjustment than when the volume is not being adjusted, allowing for improved control over volume adjustment. Providing improved visual feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the second graphical element indicates a second volume level that is based on a magnitude of the rotation of the rotatable input device (e.g., the greater the amount of rotation or the faster the rotation, the more the volume is changed from the first volume level). In some embodiments, the second volume level is different from the first volume level.

In some embodiments, as part of displaying the second graphical element on the audio media user interface, the electronic device displays the second graphical element to indicate the first volume level (e.g., 616-12 in FIG. 6F). In some embodiments, as part of displaying the second graphical element on the audio media user interface, after displaying the second graphical element to indicate the first volume level, the electronic device displays the second graphical element to indicate a fourth volume level between the first volume level and the second volume level. In some embodiments, as part of displaying the second graphical element on the audio media user interface, after displaying the second graphical element to indicate the fourth volume level, the electronic device displays the second graphical element to indicate the second volume level (e.g., 616-12 in FIG. 6G). In some embodiments, the second graphical element is continually updated as the rotatable input device is rotated (e.g., the slider becomes more or less full with rotation of the rotatable input device).

In some embodiments, in response to detecting the rotation of the rotatable input device, the electronic device displays a fourth graphical element (e.g., 616-12a) on the audio media user interface concurrently with the second graphical element (e.g., 616-12). In some embodiments, the fourth graphical element includes a portion that is common to the first graphical element and a third graphical element (e.g., 616-13) and does not indicate a volume level. In some embodiments, the fourth graphical element includes an icon shaped like a speaker, without arcs representing volume level.

In some embodiments, after detecting that the rotation of the rotatable input device has ceased (e.g., a predetermined amount of time after detecting that the rotation of the rotatable input device has ceased), the electronic device displays (808) the third graphical element (e.g., 616-13) at the first location on the audio media user interface (e.g., a version of the first graphical element that is updated to indicate the current volume level resulting from rotation of the rotatable input device). In some embodiments, the third graphical element indicates the second volume level. In some embodiments, the third graphical element is different from the second graphical element. Displaying a third graphical element that is different from the second graphical element after detecting that the rotation of the rotatable input device has ceased provides the user with improved visual feedback by displaying a dynamic volume indicator that, for example, provides simplified, less detailed volume information, which may be easier to interpret upon a quick glance, after volume adjustment has ceased compared to when the volume is being actively adjusted. Providing improved visual feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, after detecting that the rotation of the rotatable input device has ceased for more than a predetermined period of time, the electronic device ceases display of the second graphical element on the audio media user interface. In some embodiments, upon determining that a predetermined amount of time (e.g., 0.5 seconds, 1 second, 2 seconds) has passed since detecting that the rotation of the rotatable input device has ceased, the second graphical element is removed from the audio media user interface and the third graphical element is displayed.

In some embodiments, the electronic device detects a second rotation of the rotatable input device, wherein the second rotation of the rotatable input device corresponds to a request to set a volume level to a third volume level different from the second volume level (e.g., the third volume level is in the same general volume range (e.g., High, Medium, or Low) as the second volume level). In some embodiments, after detecting that the rotation of the rotatable input device has ceased, the electronic device displays the third graphical element (e.g., the same graphical element that indicates the second volume level) at the first location on the audio media user interface. In some embodiments, the third graphical element indicates the third volume level.

Note that details of the processes described above with respect to method 800 (e.g., FIG. 8) are also applicable in an analogous manner to the methods described above. For example, method 700 optionally includes one or more of the characteristics of the various methods described above with reference to method 800. For example, operation 802, 804, 806, and/or 808 can be used to display the first graphical element, second graphical element, and/or third graphical element of method 800 on the audio media user interface displayed in operation 704 of method 700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of audio media. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, account information and/or user preferences for audio media services (e.g., streaming music services), data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide audio media that is of greater interest to the user. Accordingly, use of such personal information data enables users to have calculated control of the provided content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of streaming audio services, the present technology can be configured to allow users to select to “opt in” or “opt out” of participation in the collection of personal information data during registration for services or anytime thereafter. In another example, users can select not to provide user preferences or account information for streaming audio services. In yet another example, users can select to limit the length of time preference data is maintained or entirely prohibit the development of a baseline preference profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, audio content can be selected and delivered to users by inferring preferences based on non-personal information data or a bare minimum amount of personal information, such as the content being requested by the device associated with a user, other non-personal information available to the audio content delivery services, or publicly available information.

What is claimed is:

1. An electronic device, comprising:
a housing,
a rotatable input device configured to rotate relative to the housing;
a display device;
one or more processors; and
memory storing one or more programs configured to be executed by the one or more processors, the one or more programs including instructions for:
displaying, via the display device, an audio media user interface of an application that provides an audio output, the audio media user interface including a first graphical element at a first location on the audio media user interface adjacent to the rotatable input device, the first graphical element indicating a first volume level;
detecting a rotation of the rotatable input device;
in response to detecting a rotation of the rotatable input device, displaying a second graphical element on the audio media user interface, wherein:
the second graphical element is different from the first graphical element,
the second graphical element indicates a second volume level that is based on a magnitude of the rotation of the rotatable input device, and
the second volume level is different from the first volume level; and
after detecting that the rotation of the rotatable input device has ceased, displaying a third graphical element at the first location on the audio media user interface, wherein:
the third graphical element indicates the second volume level; and
the third graphical element is different from the second graphical element.

2. The electronic device of claim 1, the one or more programs further including instructions for:
detecting a second rotation of the rotatable input device, wherein the second rotation of the rotatable input device corresponds to a request to set a volume level to a third volume level different from the second volume level; and
after detecting that the rotation of the rotatable input device has ceased, displaying the third graphical element at the first location on the audio media user interface, wherein the third graphical element indicates the third volume level.

3. The electronic device of claim 1, the one or more programs further including instructions for:
in response to detecting the rotation of the rotatable input device, displaying a fourth graphical element on the audio media user interface concurrently with the second graphical element, the fourth graphical element including a portion that is common to the first graphical element and the third graphical element and does not indicate a volume level.

4. The electronic device of claim 1, the one or more programs further including instructions for:
displaying the second graphical element to indicate the first volume level;
after displaying the second graphical element to indicate the first volume level, displaying the second graphical element to indicate a fourth volume level between the first volume level and the second volume level; and
after displaying the second graphical element to indicate the fourth volume level, displaying the second graphical element to indicate the second volume level.

5. The electronic device of claim 1, the one or more programs further including instructions for:
after detecting that the rotation of the rotatable input device has ceased for more than a predetermined period of time, ceasing display of the second graphical element on the audio media user interface.

6. A method comprising:
at an electronic device with a housing, a rotatable input device configured to rotate relative to the housing, and a display device:
displaying, via the display device, an audio media user interface of an application that provides an audio output, the audio media user interface including a first graphical element at a first location on the audio media user interface adjacent to the rotatable input device, the first graphical element indicating a first volume level;
detecting a rotation of the rotatable input device;
in response to detecting a rotation of the rotatable input device, displaying a second graphical element on the audio media user interface, wherein:
the second graphical element is different from the first graphical element,
the second graphical element indicates a second volume level that is based on a magnitude of the rotation of the rotatable input device, and
the second volume level is different from the first volume level; and
after detecting that the rotation of the rotatable input device has ceased, displaying a third graphical element at the first location on the audio media user interface, wherein:
the third graphical element indicates the second volume level; and
the third graphical element is different from the second graphical element.

7. The method of claim 6, further comprising:
detecting a second rotation of the rotatable input device, wherein the second rotation of the rotatable input device corresponds to a request to set a volume level to a third volume level different from the second volume level; and
after detecting that the rotation of the rotatable input device has ceased, displaying the third graphical element at the first location on the audio media user interface, wherein the third graphical element indicates the third volume level.

8. The method of claim 6, further comprising:
in response to detecting the rotation of the rotatable input device, displaying a fourth graphical element on the audio media user interface concurrently with the second graphical element, the fourth graphical element including a portion that is common to the first graphical element and the third graphical element and does not indicate a volume level.

9. The method of claim 6, further comprising:
displaying the second graphical element to indicate the first volume level;
after displaying the second graphical element to indicate the first volume level, displaying the second graphical element to indicate a fourth volume level between the first volume level and the second volume level; and
after displaying the second graphical element to indicate the fourth volume level, displaying the second graphical element to indicate the second volume level.

10. The method of claim 6, further comprising:
after detecting that the rotation of the rotatable input device has ceased for more than a predetermined period of time, ceasing display of the second graphical element on the audio media user interface.

11. A non-transitory computer-readable storage medium storing one or more programs configured to be executed by one or more processors of an electronic device with a housing, a rotatable input device configured to rotate relative to the housing, and a display device, the one or more programs including instructions for:
displaying, via the display device, an audio media user interface of an application that provides an audio output, the audio media user interface including a first graphical element at a first location on the audio media user interface adjacent to the rotatable input device, the first graphical element indicating a first volume level;
detecting a rotation of the rotatable input device;
in response to detecting a rotation of the rotatable input device, displaying a second graphical element on the audio media user interface, wherein:
the second graphical element is different from the first graphical element,
the second graphical element indicates a second volume level that is based on a magnitude of the rotation of the rotatable input device, and
the second volume level is different from the first volume level; and
after detecting that the rotation of the rotatable input device has ceased, displaying a third graphical element at the first location on the audio media user interface, wherein:
the third graphical element indicates the second volume level; and
the third graphical element is different from the second graphical element.

12. The non-transitory computer-readable storage medium of claim 11, the one or more programs further including instructions for:
detecting a second rotation of the rotatable input device, wherein the second rotation of the rotatable input device corresponds to a request to set a volume level to a third volume level different from the second volume level; and
after detecting that the rotation of the rotatable input device has ceased, displaying the third graphical element at the first location on the audio media user interface, wherein the third graphical element indicates the third volume level.

13. The non-transitory computer-readable storage medium of claim 11, the one or more programs further including instructions for:
in response to detecting the rotation of the rotatable input device, displaying a fourth graphical element on the audio media user interface concurrently with the second graphical element, the fourth graphical element including a portion that is common to the first graphical element and the third graphical element and does not indicate a volume level.

14. The non-transitory computer-readable storage medium of claim 11, the one or more programs further including instructions for:
displaying the second graphical element to indicate the first volume level;
after displaying the second graphical element to indicate the first volume level, displaying the second graphical element to indicate a fourth volume level between the first volume level and the second volume level; and
after displaying the second graphical element to indicate the fourth volume level, displaying the second graphical element to indicate the second volume level.

15. The non-transitory computer-readable storage medium of claim 11, the one or more programs further including instructions for:
after detecting that the rotation of the rotatable input device has ceased for more than a predetermined period of time, ceasing display of the second graphical element on the audio media user interface.
